(19) United States
(12) Patent Application Publication
(10) Pub. No.: US 2026/0111027 A1
(43) Pub. Date: Apr. 23, 2026

(54) AUTONOMOUS MOBILE ROBOT AND INDOOR LOCALIZATION METHOD THEREOF

(71) Applicant: Delta Electronics Int'l (Singapore) Pte Ltd, Singapore (SG)

(72) Inventors: Ankur Gupta, Singapore (SG); Tzu-Yi Hung, Singapore (SG); Qing Liu, Singapore (SG)

(21) Appl. No.: 18/948,145

(22) Filed: Nov. 14, 2024

(30) Foreign Application Priority Data
Oct. 18, 2024 (SG) 10202403242Y

(51) Int. Cl. G05D 1/246; G01S 17/08; G01S 17/89; G05D 107/60; G05D 111/10

(52) U.S. Cl. CPC G05D 1/246; G01S 17/08; G01S 17/89; G05D 2107/60; G05D 2111/17

(57) ABSTRACT

An autonomous mobile robot is provided, which includes a robot body, a distance sensor, and a processing circuitry. The distance sensor is mounted on the robot body, and configured to capture current spatial data of an enclosed indoor space. The processing circuitry is coupled to the distance sensor, and configured to identify multiple current anchor nodes from the current spatial data through feature extraction, and determine the current location of the robot body within the enclosed indoor space through multilateration based on the current anchor nodes.

### CROSS REFERENCE TO RELATED APPLICATIONS

This application claims priority of Singapore Patent Application No. 10202403242Y, filed on Oct. 18, 2024, the entirety of which is incorporated by reference herein.

### BACKGROUND OF THE INVENTION

### Field of the Invention

The present invention relates to autonomous navigation, and, in particular, to an autonomous mobile robot and indoor localization method thereof.

### Description of the Related Art

Autonomous navigation is a fundamental requirement for mobile robots in various applications, including delivery of items, cleaning of homes or offices, security patrol, inventory management, and ward services. In particular, for the use case of delivery of items to different units inside multi-story buildings, the autonomous mobile robot needs to ride an elevator in order to reach other floors. During elevator ride, autonomous mobile robot will be navigating inside elevator both with and without humans and non-human objects. In order to safely navigate inside an enclosed indoor space, such as an elevator with limited size and a single entrance, the requirements include: (1) High localization accuracy better than 5 cm; (2) Localization data should be available in real-time; (3) Data must remain valid all times, even in the presence of humans and non-human objects in the elevator; and (4) Lower system cost.

Achieving high localization accuracy within an enclosed indoor space such as an elevator is challenging due to its compact space and limited features. Current map-based localization techniques, such as High Definition (HD) maps with semantic information, provide centimeter-level accuracy but are resource-intensive in terms of cost and computation. Occupancy grid map-based techniques, such as Gmapping, Hector SLAM, and Cartographer, require high-quality sensor data and a feature-rich environment, which are often not available in elevators. Consequently, these techniques may suffer from degraded localization accuracy when using low-cost sensors in a feature-scarce environment like an elevator, leading to navigation failure for autonomous mobile robots.

Alternative approaches, such as multi-QR code-based localization using ceiling-mounted QR codes, have demonstrated accuracy better than 5 cm. However, implementing this method in an enclosed indoor space such as an elevator requires the installation of multiple QR codes on the ceiling of each indoor space in every building, posing a significant logistical challenge. Additionally, low-light conditions such as in older elevators can negatively impact QR code detection, further reducing localization accuracy.

Reinforcement learning-based methods for localization, which simultaneously learn localization and depth prediction tasks, offer improved feature representation. Nevertheless, these methods suffer from high computational complexity, limiting their practical application.

Overall, existing localization techniques for autonomous mobile robots face several limitations when applied to the unique constraints of indoor environments in terms of limited space and features, such as reduced localization accuracy, high computational complexity, increased system cost, and limited generalization. Therefore, there is a need for an autonomous mobile robot and indoor localization method thereof to address these limitations.

### BRIEF SUMMARY OF THE INVENTION

An embodiment of the present invention provides an autonomous mobile robot, which includes a robot body, at least one distance sensor, and a processing circuitry. The distance sensor(s) is mounted on the robot body, and configured to capture current spatial data of an enclosed indoor space. The processing circuitry is coupled to the distance sensor(s), and configured to identify multiple current anchor nodes from the current spatial data through performing feature extraction on the current spatial data, and determine the current location of the robot body within the enclosed indoor space through performing a multilateration process based on the current anchor nodes.

In an embodiment, the current anchor nodes correspond to multiple corners of the enclosed indoor space.

In an embodiment, during a prior stage, the distance sensor(s) is further configured to capture prior spatial data of the enclosed indoor space, and the processing circuitry is further configured to identify multiple prior anchor nodes corresponding to the corners of the enclosed indoor space from the prior spatial data through performing feature extraction on the prior spatial data. During a localization stage, the processing circuitry is further configured to detect anomalous current anchor nodes by comparing the current anchor nodes and the prior anchor nodes in an aligned coordinate system using a transformation matrix between the prior spatial data and the current spatial data, and replace the anomalous current anchor nodes with corresponding prior anchor nodes transformed using the transformation matrix, to determine the current location of the robot body within the enclosed indoor space.

In an embodiment, the corners of the enclosed indoor space are free from occlusion and reflectors during the prior stage.

In an embodiment, the distance sensor(s) is a LiDAR, and the current spatial data captured by the LiDAR is a 2D point cloud, each point of which is represented in polar coordinates, including a radial coordinate and an angular coordinate.

In an embodiment, the processing circuitry is further configured to derive relative coordinates for each of the current anchor nodes from the corresponding polar coordinates, and determine the current location of the robot body within the enclosed indoor space based on the relative coordinates and the radial coordinates of the current anchor nodes.

In an embodiment, the processing circuitry is further configured to determine the current location of the robot body within the enclosed indoor space by using a non-linear optimizer to solve equations based on the relative coordinates and the radial coordinates of the current anchor nodes.

In an embodiment, the processing circuitry is further configured to identify the current anchor nodes from the current spatial data by minimizing a convex function representing the current spatial data.

In an embodiment, the processing circuitry is further configured to navigate the robot body to a target location within the enclosed indoor space based on the determined current location of the robot body and the target location.

In an embodiment, the multilateration process is used to derive the current location of the robot using four current anchor nodes.

An embodiment of the present invention provides an indoor localization method which is applied in an autonomous mobile robot. The method includes capturing current spatial data of an enclosed indoor space using at least one distance sensor mounted on a robot body of the autonomous mobile robot, identifying multiple current anchor nodes from the current spatial data through performing feature extraction on the current spatial data, and determining the current location of the robot body within the enclosed indoor space through performing a multilateration process based on the enclosed current anchor nodes.

The autonomous mobile robot and indoor localization method provided herein are designed to improve localization accuracy, computational efficiency, and robustness, making the system more reliable and effective in a wide range of indoor environments. By leveraging advanced feature extraction and localization techniques, the proposed solution ensures precise navigation even in feature-limited or dynamic conditions, such as occluded corners. Additionally, the high generalization capability allows the autonomous mobile robot to be seamlessly adapted to various indoor spaces, such as elevators, offices, warehouses, and public buildings, without requiring extensive customization or additional infrastructure.

### BRIEF DESCRIPTION OF THE DRAWINGS

The present invention can be more fully understood by reading the subsequent detailed description and examples with references made to the accompanying drawings, wherein:

FIG. 1 is the block diagram of an autonomous mobile robot, according to an embodiment of the present disclosure;

FIG. 2 is the flow diagram of an indoor localization method applied in the autonomous mobile robot of FIG. 1;

FIG. 3 illustrates a typical example of spatial data, according to an embodiment of the present disclosure;

FIG. 4A-4E illustrates the an example of the derivation process of relative coordinates for the anchor nodes, according to an embodiment of the present disclosure;

FIG. 4F illustrates the required information for determining the current location of the robot body RB, according to an embodiment of the present disclosure;

FIG. 5A illustrates an example of spatial data with occlusion in the corners of the enclosed indoor space, according to an embodiment of the present disclosure;

FIG. 5B illustrates an example of spatial data with reflectors in the corners of the enclosed indoor space, according to an embodiment of the present disclosure;

FIG. 6A is the flow diagram of the prior stage of the indoor localization method, according to an embodiment of the present disclosure; and

FIG. 6B is the flow diagram of the localization stage of the indoor localization method, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

The descriptions provided below for embodiments of devices or systems are also applicable to embodiments of methods, and vice versa.

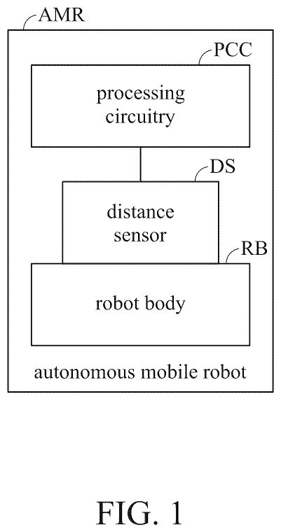

FIG. 1 is the block diagram of an autonomous mobile robot AMR, according to an embodiment of the present disclosure. As shown in FIG. 1, the autonomous mobile robot AMR includes a robot body RB, at least one distance sensor DS, and a processing circuitry PCC.

The autonomous mobile robot AMR is a self-navigating robot system capable of operating in various indoor environments and performing a wide range of tasks autonomously. The applications of the autonomous mobile robot AMR includes but not limited to delivery of items, cleaning of homes or offices, security patrol, inventory management, and ward services. In some implementations, during the navigation through the indoor spaces, the autonomous mobile robot AMR may be designed to adapt to dynamic environments and interact with surrounding humans and objects to fulfill its designated tasks efficiently and safely.

The robot body RB serves as the physical structure and foundation of the autonomous mobile robot AMR. Additionally, the robot body RB provides support for various components, including the distance sensor(s) DS, and houses essential elements such as the processing circuitry PCC, power supply, motor systems, and communication modules. In the embodiments of the present disclosure, the robot body RB functions as both the carrier of the distance sensor(s) and the primary entity for indoor localization. By accurately determining the current location of the robot body RB within the enclosed indoor space, the autonomous mobile robot AMR ensures precise navigation and task execution in dynamic environments.

The distance sensor(s) DS is a sensing device used to measure distances to surrounding walls and objects within the environment. In various implementations, the distance sensor(s) DS operates using technologies such as LiDAR, ultrasonic, or infrared to capture spatial data associated with the surrounding environment. In the embodiments of the present disclosure, the distance sensor(s) DS is mounted on the robot body RB and configured to capture current spatial data of the enclosed indoor space where the robot body RB is located. It should be noted that although FIG. 1 depicts only a single distance sensor DS, in some embodiments, multiple distance sensors may be deployed to overcome the limitations of the field of view (FoV) of individual sensors and provide a more comprehensive and accurate capture of the spatial data. More details about the functionality of the distance sensor(s) DS are elaborated hereinafter.

The processing circuitry PCC is a specifically designed circuitry that comprises one or more electronic circuits, such as an application-specific integrated circuit (ASIC), a field-programmable gate array (FPGA), or a system-on-chip (SoC), but the present disclosure is not limited thereto. In the embodiments of the present disclosure, the processing circuitry PCC is coupled to the distance sensor(s) DS, and configured to identify multiple current anchor nodes from the current spatial data through feature extraction, and determine the current location of the robot body RB within the enclosed indoor space through multilateration based on the current anchor nodes. More details are elaborated hereinafter.

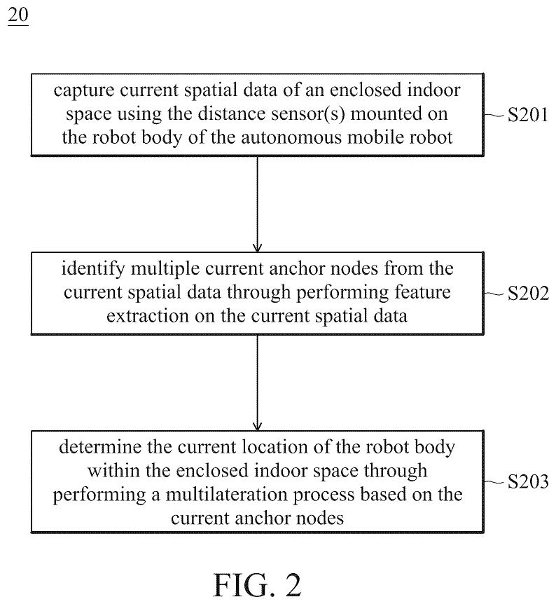

FIG. 2 is the flow diagram of an indoor localization method 20 applied in the autonomous mobile robot AMR of FIG. 1, according to an embodiment of the present disclosure. As shown in FIG. 2, the method 20 includes steps S201-S203.

In step S201, current spatial data of an enclosed indoor space is captured using the distance sensor(s) DS mounted on the robot body RB of the autonomous mobile robot AMR. Next, the method proceeds to step S202.

In step S202, multiple current anchor nodes are identified from the current spatial data through performing feature extraction on the spatial data captured by the distance sensor(s) DS. Next, the method proceeds to step S203.

In step S203, the current location of the robot body RB within the enclosed indoor space is determined through performing a multilateration process based on the current anchor nodes.

The spatial data refers to real-time information captured by the distance sensor(s) DS that represents the geometric and positional characteristics of the surrounding indoor environment, including details about the location and distance of objects, walls, and other structural features relative to the robot body RB. The spatial data can be, for example, a 2D point cloud, a panoramic depth map, or a series of distance measurements, but the present disclosure is not limited thereto.

The anchor nodes refer to specific feature points within the enclosed indoor space that are identified from the spatial data. These feature points may represent key structural elements, such as corners, edges, distinguishable landmarks, or other unique structural patterns that can be used as references for localizing the robot body RB.

The feature extraction performed in step S202 may involve processing the current spatial data to identify distinctive geometric features within the enclosed indoor space. Specifically, this process involves detecting specific elements such as corners, edges, distinguishable landmarks, or other unique structural patterns that can serve as reliable anchor points for localization. Various implementations for feature extraction include Random Sample Consensus (RANSAC), Iterative Closest Point (ICP), Harris Corner Detector, or principal component analysis (PCA), but the present disclosure is not limited thereto.

The multilateration process in step S203 may involve calculating the current location of the robot body RB within the enclosed indoor space by using the geometric relationship between the robot body RB and the anchor nodes. This is based on the principle that the location of an object can be identified if the distances to multiple known reference points are available. Although the number of anchor nodes required for the multilateration process is not strictly limited, in a preferred embodiment, four or more anchor nodes are involved in the multilateration process to derive the current location of the robot body RB. Compared to a triangular approach that relies on only three anchor nodes, the multilateration process using four or more anchor nodes provides additional reference information, allowing for improved error correction and more robust handling of uncertainties, and helps to enhance the precision of the calculated position, particularly in certain cases, for example, when the spatial data is a 2D point cloud with limited precision.

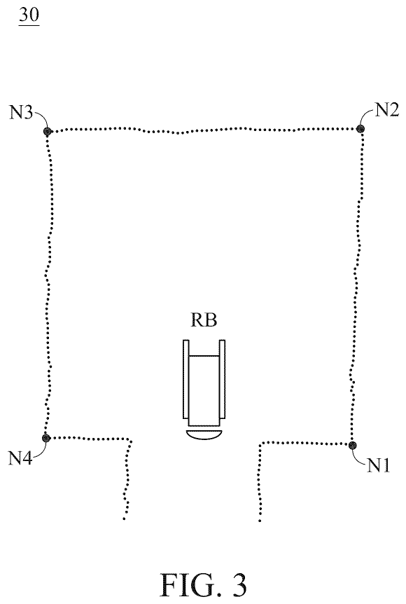

FIG. 3 illustrates a typical example of spatial data 30, according to an embodiment of the present disclosure. In this embodiment, the anchor nodes, denoted as N1-N4 in FIG. 3, correspond to the four corners of the enclosed indoor space (e.g., in an elevator) where the robot body RB is located. The multilateration process in step S203 involves using these anchor nodes N1-N4 to derive the relative location of the robot body RB.

It should be noted that the enclosed indoor space illustrated in FIG. 3 is substantially a rectangular shape with four corners, but this is merely an example, rather than a limitation. In other cases, the enclosed indoor space where the robot body RB is located may have any other shape, and the number of anchor nodes is not limited. For instance, a triangular indoor space would have three anchor nodes, while a hexagonal indoor space would have six anchor nodes.

In an embodiment, the distance sensor(s) DS is a LiDAR, and the spatial data captured by the LiDAR is a 2D point cloud. Since LiDAR scans the surrounding environment through rotation, each point of the 2D point cloud is represented in polar coordinates (r, θ), including a radial coordinate r and an angular coordinate θ, which respectively represent the distance of that point from the robot body RB and the angle of that point relative to a reference direction of the robot body RB.

In a further embodiment, the identification for the anchor nodes from the spatial data can be implemented by minimizing a convex function representing the spatial data. In other words, the feature (corner) extraction problem inside the enclosed indoor space is considered as a problem of convex function minimization. The 2D point cloud for the enclosed indoor space is represented in form of convex function, and then minimization is performed to extract corner vectors. Mathematically, this process can be represented as follows:

Let F be the function representing the 2D point cloud for the enclosed indoor space, and
let G ∩ F (i.e., G is a subset function of F), then, r ∈ F is a local minima if F(r) <
F(s) for all s ∈ G, s ≠ r, r, s ∈ R
The extracted corner vectors are then represented as Z = [P₁ P₂ . . . Pₙ], where
P₁, P₂, . . . , Pₙ = (r₁, θ₁), (r₂, θ₂), . . . , (rₙ, θₙ). r₁, r₂, . . . rₙ are the radial coordinates and
θ₁, θ₂, . . . , θₙ are the corresponding angular coordinate for the extracted corners.

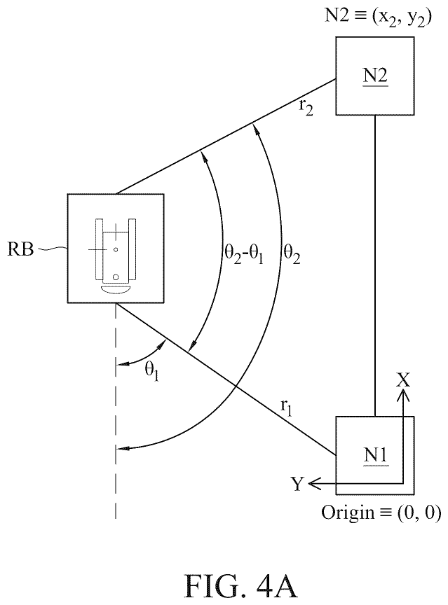

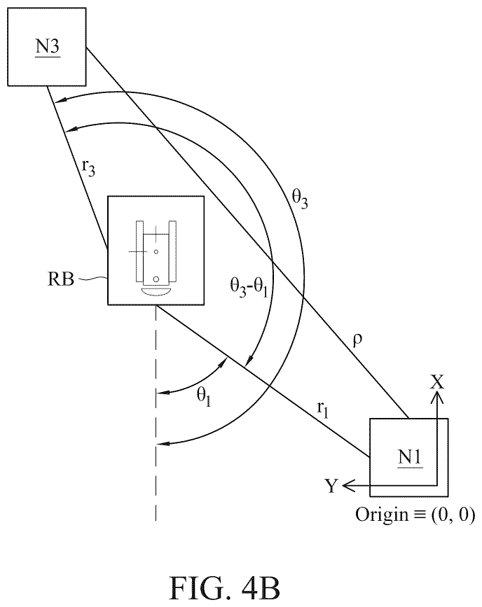

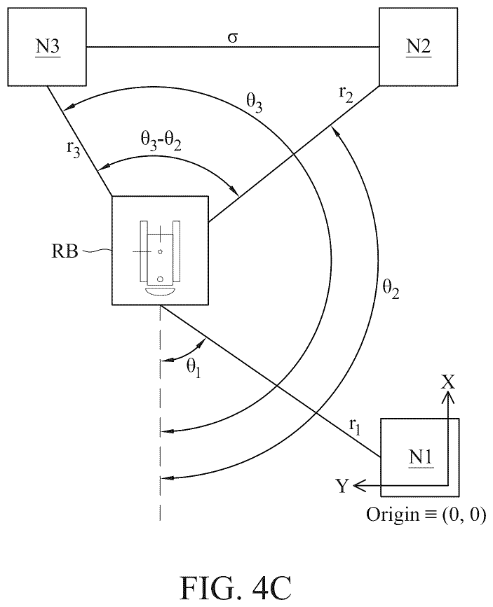

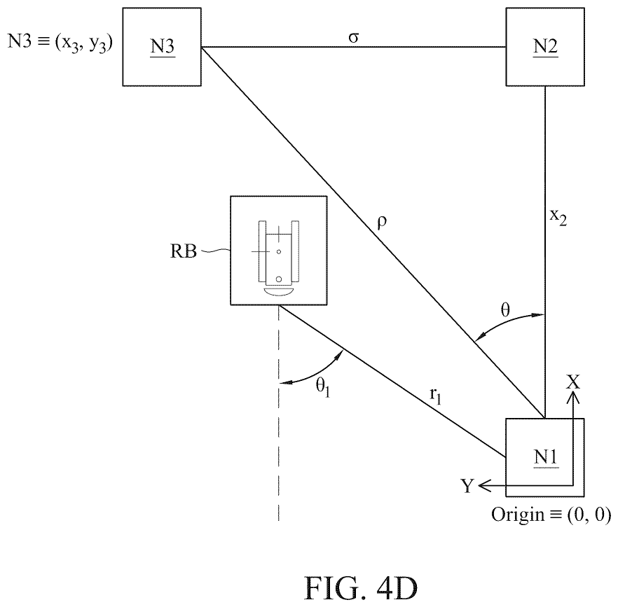

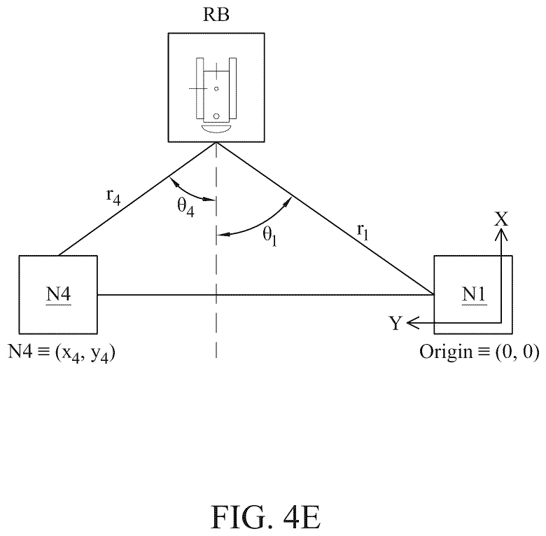

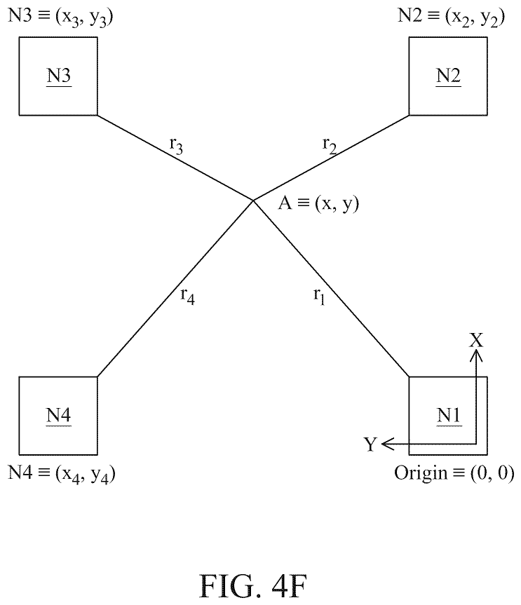

In an embodiment, step S203 further involves deriving the relative coordinates for each of the current anchor nodes from the corresponding polar coordinates, and determining the current location of the robot body RB within the enclosed indoor space based on the relative coordinates and the radial coordinates of the current anchor nodes. More details are elaborated hereinafter with reference to FIGS. 4A-4F.

FIG. 4A-4E illustrates an example of the derivation process of relative coordinates for the anchor nodes, and FIG. 4F illustrates the required information for determining the current location of the robot body RB, according to an embodiment of the present disclosure. In this example, four corners are extracted, and the corresponding anchor nodes are denoted as N1-N4 in FIGS. 4A-4F. In addition, the anchor node N1 is considered as origin. Consequently, the localization problem can be formulated as follows:

Let A ≡ (x, y) be the unknown coordinate of the robot body RB within
the enclosed indoor space and (x₂, y₂), (x₃, y₃), (x₄, y₄) be the coordinates
of the anchor nodes N2, N3, N4 with respect to the anchor node
N1 respectively.

Refer to FIG. 4A. According to the law of cosines, the coordinates (x₂, y₂) of the current anchor node N2 is calculated as follows:

$${x}_{2} = \sqrt{{{r}_{1}}^{2} + {{r}_{2}}^{2} - 2 {r}_{1} {r}_{2} cos ( {θ}_{2} - {θ}_{1} )}$$

$${y}_{2} = 0 where$$

$$( {r}_{I} , {θ}_{1} ) and ( {r}_{2} , {θ}_{2} ) are obtained from Z .$$

Next, refer to FIG. 4B. According to the law of cosines, the distance ρ between the anchor nodes N1 and N3 is calculated as follows:

$$ρ = \sqrt{{{r}_{1}}^{2} + {{r}_{3}}^{2} - 2 {r}_{1} {r}_{3} cos ( {θ}_{3} - {θ}_{1} )} where$$

$$( {r}_{I} , {θ}_{1} ) and ( {r}_{3} , {θ}_{3} ) are obtained from Z .$$

Next, refer to FIG. 4C. According to the law of cosines, the distance o between the anchor nodes N2 and N3 is calculated as follows:

$$σ = \sqrt{{{r}_{2}}^{2} + {{r}_{3}}^{2} - 2 {r}_{2} {r}_{3} cos ( {θ}_{3} - {θ}_{2} )} where$$

$$( {r}_{2} , {θ}_{2} ) and ( {r}_{3} , {θ}_{3} ) are obtained from Z .$$

Next, refer to FIG. 4D. According to the law of cosines, the coordinates (x₃, y₃) of the anchor node N3 is calculated as follows:

$$θ = {cos}^{- 1} [ ( {ρ}^{2} + {x}_{2}^{2} - {σ}^{2} ) / ( 2 ρ {x}_{2} ) ]$$

$${x}_{3} = ρcosθ$$

$${y}_{3} = ρ sin θ$$

Next, refer to FIG. 4E. According to the law of cosines, the coordinates (x₄, y₄) of the anchor node N4 is calculated as follows:

$${x}_{4} = 0$$

$${y}_{4} = \sqrt{{{r}_{1}}^{2} + {{r}_{4}}^{2} - 2 {r}_{1} {r}_{4} cos ( {θ}_{4} + {θ}_{1} )}$$

Next, refer to FIG. 4F. As shown in FIG. 4F, the information required for determining the coordinate (x, y) of the robot body RB includes the relative coordinates (x₂, y₂), (x₃, y₃), and (x₄, y₄) of the anchor node N2-N4 with respect to the anchor node N1, as well as the radial coordinates r₁, r₂, r₃, and r₄ of the anchor nodes N1-N4, respectively. With all the information, the current location of the robot body RB, represented by the coordinate (x, y), can be determined through multilateration.

In a further embodiment, the aforementioned multilateration involves using a non-linear optimizer to solve equations based on the relative coordinates and the radial coordinates of the current anchor nodes. In the example presented in FIG. 4F, the Euclidian distances {A,N₁}, {A,N₂}, {A,N₃}, and {A, N₄} between the robot body RB and the anchor nodes N1-N4 can be written as the following equations:

$$\{ A , {N}_{1} \} : \sqrt{{x}^{2} + {y}^{2}} = {r}_{1}$$

$$\{ A , {N}_{2} \} : \sqrt{{( x - {x}_{2} )}^{2} + {( y - {y}_{2} )}^{2}} = {r}_{2}$$

$$\{ A , {N}_{3} \} : \sqrt{{( x - {x}_{3} )}^{2} + {( y - {y}_{3} )}^{2}} = {r}_{3}$$

$$\{ A , {N}_{4} \} : \sqrt{{( x - {x}_{4} )}^{2} + {( y - {y}_{4} )}^{2}} = {r}_{4}$$

It should be noted that these equations are nonlinear, and the radial coordinates r₁, r₂, r₃, and r₄ measured by the distance sensor(s) DS may contain errors. In such cases, a non-linear optimizer, such as the Levenberg-Marquardt algorithm or the Gauss-Newton algorithm, can be used to find an optimal approximate solution that satisfies all the equations.

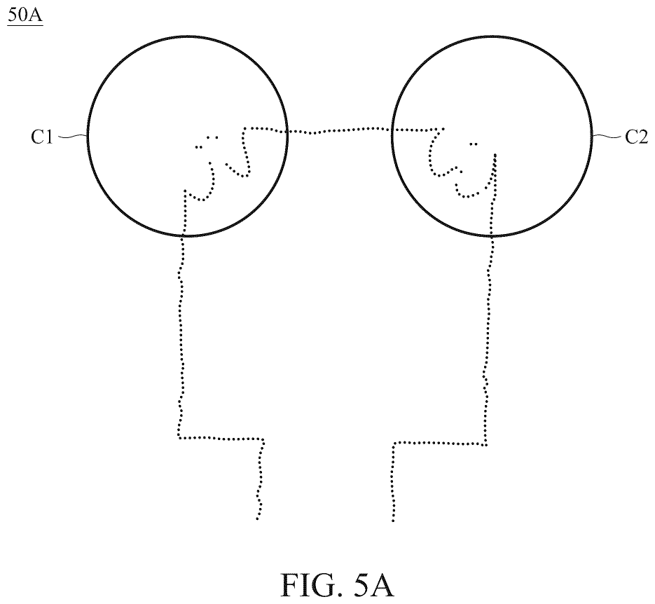

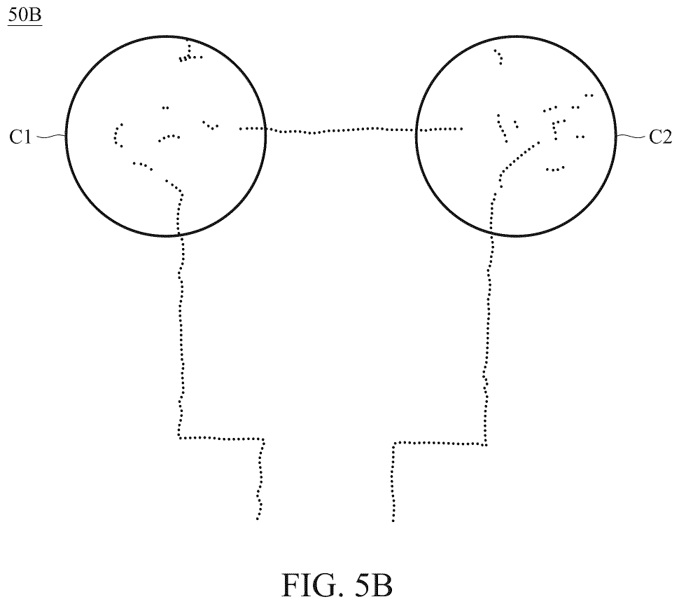

FIG. 5A illustrates an example of spatial data 50A with occlusion in the corners C1 and C2 of the enclosed indoor space, according to an embodiment of the present disclosure. The occlusion in the corners C1 and C2 may be caused by various factors, such as the presence of people standing in the corners or objects temporarily placed in these areas. Such occlusions can obstruct the distance sensor(s) DS from accurately capturing the spatial data of these corners, resulting in incomplete or distorted representation of the indoor environment. This can lead to errors in identifying the anchor nodes, which may subsequently affect the accuracy of the localization for the robot body RB.

FIG. 5B illustrates an example of spatial data 50B with reflectors in the corners C1 and C2 of the enclosed indoor space, according to an embodiment of the present disclosure. The presence of reflectors, such as mirrors or other reflective surfaces, in the corners C1 and C2 can cause multiple reflections of the LiDAR signals, resulting in inaccurate or misleading spatial data. As shown in FIG. 5B, the spatial data in the regions near corners C1 and C2 exhibit scattered and inconsistent points, which are indicative of reflection artifacts. These artifacts can lead to erroneous identification of the current anchor nodes, as the reflections may be falsely interpreted as actual environmental features. Consequently, the localization accuracy of the robot body RB can be affected.

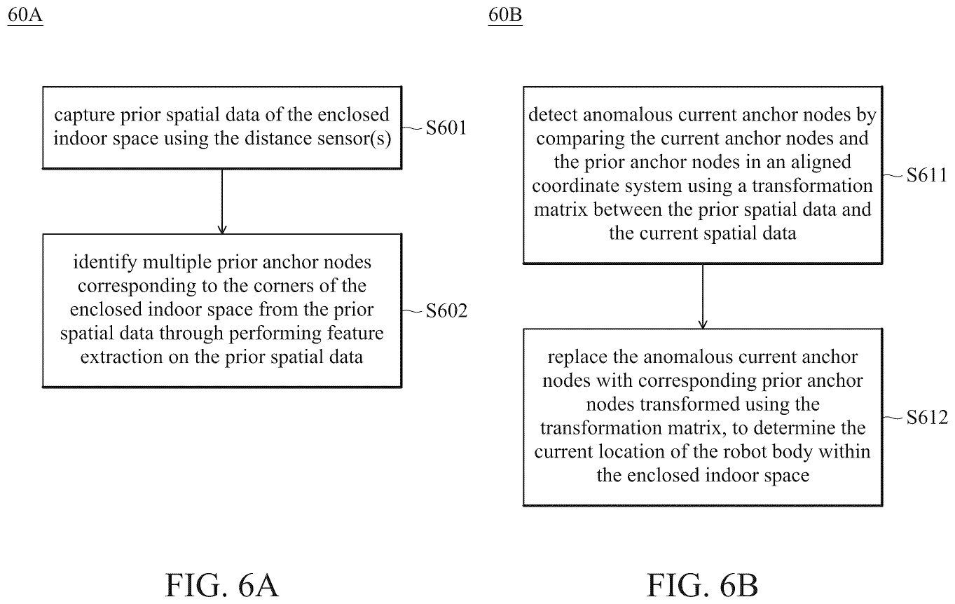

In an embodiment, prior knowledge of the indoor environment is utilized to address the issues presented in FIG. 5A and FIG. 5B. Specifically, pre-stored reference spatial data that includes the expected locations of the anchor nodes are referenced in step S203 of the embodiment of FIG. 2 to determine the current location of the robot body. During the localization stage, the current spatial data is compared with the prior spatial data to identify discrepancies caused by occlusions or reflections. If anomalies are detected in the current anchor nodes, such as missing or misaligned points, the anomalous anchor nodes are replaced with the corresponding anchor nodes derived from the prior knowledge. More details are elaborated hereinafter with reference to FIG. 6A and FIG. 6B.

FIG. 6A is the flow diagram of the prior stage 60A of the indoor localization method, according to an embodiment of the present disclosure. As shown in FIG. 6A, steps S601 and 602 are involved during the prior stage 60A.

In step S601, prior spatial data of the enclosed indoor space is captured using the distance sensor(s) DS. In the subsequent step S602, multiple prior anchor nodes corresponding to the corners of the enclosed indoor space are identified from the prior spatial data through performing feature extraction on the prior spatial data.

The prior anchor nodes identified during the prior stage 60A will be referenced during the localization stage as the expected locations of the anchor nodes, so as to correct any anomalous current anchor nodes. In a preferred embodiment, the corners of the enclosed indoor space are free from occlusion and reflectors during the prior stage 60A. This allows the autonomous mobile robot system to capture an accurate and unobstructed reference of the locations of the anchor nodes, and provides a reliable baseline for comparing and correcting the current anchor nodes in the localization stage.

FIG. 6B is the flow diagram of the localization stage 60B of the indoor localization method, according to an embodiment of the present disclosure. As shown in FIG. 6B, steps S611 and 612 are involved during the prior stage 60B.

In step S611, anomalous current anchor nodes are detected by comparing the current anchor nodes and the prior anchor nodes in an aligned coordinate system using a transformation matrix between the prior spatial data and the current spatial data. In other words, the transformation matrix is used to align the current anchor nodes and the prior anchor nodes to the same coordinate system for comparison, thereby detecting any discrepancies or anomalies. The transformation matrix can be obtained through various approaches, such as using point cloud registration techniques like Iterative Closest Point (ICP) or feature matching algorithms. These approaches calculate the optimal transformation matrix by minimizing the error between corresponding points in the prior and current spatial data. Alternatively, tools such as the ROS navigation stack provide built-in functionalities for generating transformation matrices between different coordinate systems.

In step S612, the anomalous current anchor nodes are replaced with corresponding prior anchor nodes transformed using the transformation matrix, to determine the current location of the robot body within the enclosed indoor space. More specifically, the transformation matrix is applied to the prior anchor nodes to align them with the current spatial data, ensuring that the coordinates of the prior anchor nodes correspond to the same frame of reference as the current spatial data. The anomalous current anchor nodes can then be replaced with reliable, pre-validated prior anchor nodes. Thereby, the localization for the autonomous mobile robot becomes more reliable and robust, as it avoids using erroneous current anchor nodes that may have been affected by environmental factors such as occlusions or reflections.

In an embodiment, the processing circuitry PCC is further configured to navigate the robot body RB to a target location within the enclosed indoor space based on the determined current location of the robot body and the target location. Specifically, the processing circuitry PCC uses the current location of the robot body RB as a starting point and generates an optimal path to the target location by taking into account obstacles and constraints within the indoor environment. The navigation process may involve calculating a series of waypoints or using a path planning algorithm, such as A-star or Dijkstra's algorithm, to ensure efficient and safe movement. Additionally, the processing circuitry PCC can continuously monitor the current location of the robot body RB relative to the planned path and dynamically adjust the path if unexpected obstacles are detected or if environmental conditions change.

In a further embodiment, the target location can also be determined based on the robot's specific tasks and can dynamically adapt according to the current spatial data. For instance, for a delivery robot, the target location may be initially set to the position closest to the elevator door, allowing the robot to quickly exit the elevator upon reaching the designated floor. However, if the current spatial data indicates that this area is occupied, the processing circuitry PCC can adjust the target location to another suitable spot within the elevator to avoid delays. For a cleaning robot, the target location may be set to a certain corner of the elevator, minimizing interference with passengers and other objects. However, if the current spatial data indicates that corner is occupied, the processing circuitry PCC can adjust the target location to another corner. Additionally, the processing circuitry PCC can incorporate a priority mechanism for determining the target location, where certain areas of the enclosed indoor space are prioritized based on the robot's task. For instance, in a high-traffic scenario, the cleaning robot may prioritize moving to less congested areas, while still optimizing its path to ensure task efficiency. The combination of task-specific goals, dynamic adjustment based on current spatial data, and priority-based decision-making ensures that the autonomous mobile robot AMR can effectively navigate and operate in complex indoor environments.

The autonomous mobile robot and indoor localization method provided herein are designed to improve localization accuracy, computational efficiency, and robustness, making the system more reliable and effective in a wide range of indoor environments. By leveraging advanced feature extraction and localization techniques, the proposed solution ensures precise navigation even in feature-limited or dynamic conditions, such as occluded corners. Additionally, the high generalization capability allows the autonomous mobile robot to be seamlessly adapted to various indoor spaces, such as elevators, offices, warehouses, and public buildings, without requiring extensive customization or additional infrastructure.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An autonomous mobile robot, comprising:
a robot body;
at least one distance sensor, mounted on the robot body, configured to capture current spatial data of an enclosed indoor space; and
a processing circuitry, coupled to the at least one distance sensor, configured to:
identify multiple current anchor nodes from the current spatial data through performing feature extraction on the current spatial data; and
determine a current location of the robot body within the enclosed indoor space through performing a multilateration process based on the current anchor nodes.

2. The autonomous mobile robot as claimed in claim 1, wherein the current anchor nodes correspond to multiple corners of the enclosed indoor space.

3. The autonomous mobile robot as claimed in claim 2, wherein during a prior stage, the at least one distance sensor is further configured to capture prior spatial data of the enclosed indoor space, and the processing circuitry is further configured to identify multiple prior anchor nodes corresponding to the corners of the enclosed indoor space from the prior spatial data through performing feature extraction on the prior spatial data;
wherein during a localization stage, the processing circuitry is further configured to:
detect anomalous current anchor nodes by comparing the current anchor nodes and the prior anchor nodes in an aligned coordinate system using a transformation matrix between the prior spatial data and the current spatial data; and
replace the anomalous current anchor nodes with corresponding prior anchor nodes transformed using the transformation matrix, to determine the current location of the robot body within the enclosed indoor space.

4. The autonomous mobile robot as claimed in claim 3, wherein the corners of the enclosed indoor space are free from occlusion and reflectors during the prior stage.

5. The autonomous mobile robot as claimed in claim 2, wherein the at least one distance sensor is a LiDAR, and the current spatial data captured by the LiDAR is a 2D point cloud, each point of which is represented in polar coordinates, including a radial coordinate and an angular coordinate.

6. The autonomous mobile robot as claimed in claim 5, wherein the processing circuitry is further configured to derive relative coordinates for each of the current anchor nodes from the corresponding polar coordinates, and determine the current location of the robot body within the enclosed indoor space based on the relative coordinates and the radial coordinates of the current anchor nodes.

7. The autonomous mobile robot as claimed in claim 6, wherein the processing circuitry is further configured to determine the current location of the robot body within the enclosed indoor space by using a non-linear optimizer to solve equations based on the relative coordinates and the radial coordinates of the current anchor nodes.

8. The autonomous mobile robot as claimed in claim 5, wherein the processing circuitry is further configured to identify the current anchor nodes from the current spatial data by minimizing a convex function representing the current spatial data.

9. The autonomous mobile robot as claimed in claim 1, wherein the processing circuitry is further configured to navigate the robot body to a target location within the enclosed indoor space based on the determined current location of the robot body and the target location.

10. The autonomous mobile robot as claimed in claim 1, wherein the multilateration process is used to derive the current location of the robot body using four or more current anchor nodes.

11. An indoor localization method, applied in an autonomous mobile robot, the method comprising:
capturing current spatial data of an enclosed indoor space using at least one distance sensor mounted on a robot body of the autonomous mobile robot;
identifying multiple current anchor nodes from the current spatial data through performing feature extraction on the current spatial data; and
determining a current location of the robot body within the enclosed indoor space through performing a multilateration process based on the current anchor nodes.

12. The method as claimed in claim 11, wherein the current anchor nodes correspond to multiple corners of the enclosed indoor space.

13. The method as claimed in claim 12, further comprising:
during a prior stage, capturing prior spatial data of the enclosed indoor space using the at least one distance sensor, and identifying multiple prior anchor nodes corresponding to the corners of the enclosed indoor space from the prior spatial data through performing feature extraction on the prior spatial data;
during a localization stage, detecting anomalous current anchor nodes by comparing the current anchor nodes and the prior anchor nodes in an aligned coordinate system using a transformation matrix between the prior spatial data and the current spatial data, and replacing the anomalous current anchor nodes with corresponding prior anchor nodes transformed using the transformation matrix, to determine the current location of the robot body within the enclosed indoor space.

14. The method as claimed in claim 13, wherein the corners of the enclosed indoor space are free from occlusion and reflectors during the prior stage.

15. The method as claimed in claim 12, wherein the at least one distance sensor is a LiDAR, and the current spatial data captured by using the LiDAR is a 2D point cloud, each point of which is represented in polar coordinates, including a radial coordinate and an angular coordinate.

16. The method as claimed in claim 15, wherein determining the current location of the robot body within the enclosed indoor space further comprises:
deriving relative coordinates for each of the current anchor nodes from the corresponding polar coordinates, and determining the current location of the robot body within the enclosed indoor space based on the relative coordinates and the radial coordinates of the current anchor nodes.

17. The method as claimed in claim 16, wherein determining the current location of the robot body within the enclosed indoor space further comprises:
determining the current location of the robot body within the enclosed indoor space by using a non-linear optimizer to solve equations based on the relative coordinates and the radial coordinates of the current anchor nodes.

18. The method as claimed in claim 15, further comprising:
identifying the current anchor nodes from the current spatial data by minimizing a convex function representing the current spatial data.

19. The method as claimed in claim 11, further comprising:
navigating the robot body to a target location within the enclosed indoor space based on the determined current location of the robot body and the target location.

20. The method as claimed in claim 11, wherein the multilateration process is used to derive the current location of the robot body using four or more current anchor nodes.
